(19) United States
(12) Patent Application Publication
(10) Pub. No.: US 2013/0157686 A1
(43) Pub. Date: Jun. 20, 2013

(54) ELECTRONIC DEVICE AND TRACKING METHOD

(71) Applicants: CHING-CHUNG WU, Tu-Cheng (TW); YOUNG-WAY LIU, Tu-Cheng (TW)

(72) Inventors: CHING-CHUNG WU, Tu-Cheng (TW); YOUNG-WAY LIU, Tu-Cheng (TW)

(73) Assignee: HON HAI PRECISION INDUSTRY CO., LTD., Tu-Cheng (TW)

(21) Appl. No.: 13/465,041

(22) Filed: May 7, 2012

(30) Foreign Application Priority Data
Dec. 15, 2011 (CN) 201110420903.1

(51) Int. Cl. H04W 24/00; H04W 52/02

(52) U.S. Cl. 455/456.1

(57) ABSTRACT

The disclosure provides an electronic device and a tracking method adapted for the apparatus. The device predefines a time period according to the requirement of a user and an alarm or information receiving party with which the device can communicate. If the device remains stationary during the time period, the device acquires a current location thereof and sends the location to the receiving party using another phone number, or an e-mail address. Therefore, the user associated with the receiving party can track and know the location of the device in real time.

### BACKGROUND

1. Technical Field

The present disclosure relates to electronic devices and, particularly, to an electronic device and a tracking method adapted for the device.

2. Description of Related Art

The size of electronic devices has become smaller and smaller. If the user forgets the place where the electronic device was last put aside, it may be difficult for the user to find the electronic device due to the size of the electronic device, and the device may be lost for good.

Therefore, it is necessary to provide an electronic device and a tracking method capable of overcoming the limitations described.

### BRIEF DESCRIPTION OF THE DRAWINGS

FIG. 1 is a block diagram of an electronic device, according to an exemplary embodiment.

FIG. 2 is a block diagram of a control unit of the electronic device of FIG. 1, according to an exemplary embodiment.

FIG. 3 is a flowchart of a method for tracking the electronic device of FIG. 1, according to an exemplary embodiment.

### DETAILED DESCRIPTION

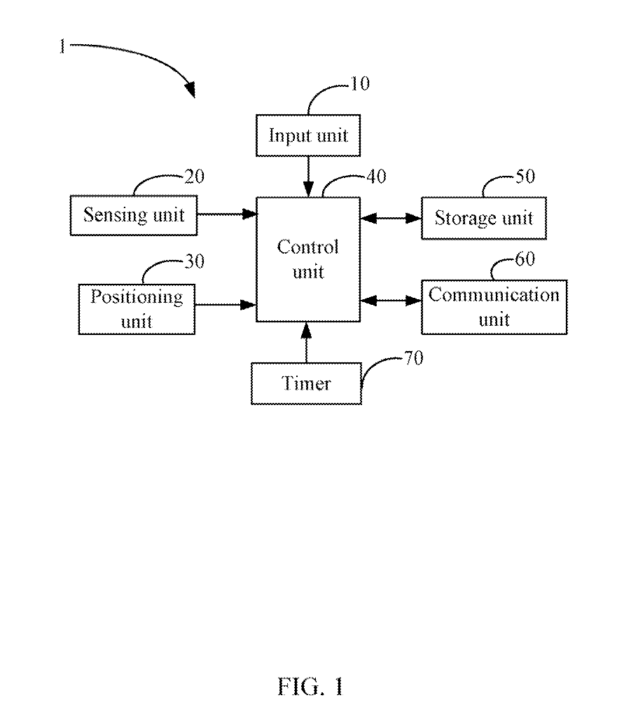

FIG. 1 is a block diagram of an electronic device 1, according to an exemplary embodiment. The electronic device 1 may be a portable device, such as a mobile phone or a PDA. The electronic device 1 includes an input unit 10, a sensing unit 20, a positioning unit 30, a control unit 40, a storage unit 50, and a communication unit 60. The input unit 10 generates signals in response to user inputs. The communication unit 60 communicates with other electronic devices. The storage unit 50 stores information.

The positioning unit 30 updates a location of the electronic device 1 in real time. In the embodiment, the positioning unit 30 is a GPS (Global Positioning System) receiver. For example, when the electronic device 1 is positioned on XXX floor, XXX building, XXX road, XXX district, XXX city, the positioning unit 30 updates the location of the electronic device 1 as XXX floor, XXX building, XXX road, XXX district, XXX city.

The sensing unit 20 senses any movement of the electronic device 1 in real time and generate a signal when the electronic device 1 moves. Because the user carries the electronic device 1 according to habit, the motion of the electronic device 1 indirectly represents the movements of the user. When the motion of the electronic device 1 is not consistent with the movements of the user, it is regarded as the user leaving the electronic device 1 behind, due to forgetting to pick up the electronic device 1, or losing the electronic device, etc. In the embodiment, the sensing unit 20 is a G-sensor.

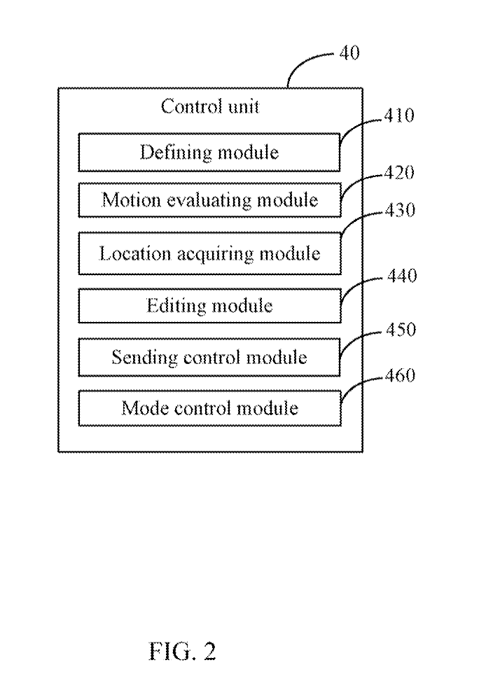

As shown in FIG. 2, the control unit 40 further includes a motion evaluating module 420, a location acquiring module 430, an editing module 440, and a sending control module 450. The motion evaluating module 420 determines whether the sensing unit 20 generates a signal within a preset time period. When the sensing unit 20 has generated a signal within the preset time period, that means that a user of the electronic device 1 is carrying the electronic device 1 in the preset time period, and when the sensing unit 20 does not generate a signal within the preset time period, that means that the user may have lost the electronic device 1 or left it in a previous location.

The location acquiring module 430 acquires a current location of the electronic device 1 from the positioning unit 30 when the sensing unit 20 does not generate a signal within the preset time period.

The editing module 440 edits and issues an alarm containing the location of the electronic device 1 from the location acquiring module 430. For example, the alarm may contain “this is an assistant of the electronic device, and the electronic device is now positioned on XXX floor, XXX building, XXX road, XXX district, XXX city”. The editing module 440 may insert actual and factual pieces of information in place of the letters “XXX” which, in the alarm, represent general or particular locations. The sending control module 450 controls the communication unit 60 to send the edited alarm to a preset receiving party in a predetermined sending manner.

Furthermore, the control unit 40 includes a defining module 410, the electronic device 1 includes a function interface, and the defining module 410 defines the length of the preset time period and the preset receiving party on the function interface in response to user inputs from the input unit 10. The preset time period is defined by the user using the electronic device 1, for example, the preset time period may be set as two hours. The preset receiving party is relative to the user of the electronic device 1. For example, the preset receiving party may be a phone number of the user, or another phone number of the user, or an email address of the user. The storage unit 20 stores the preset time period and the preset receiving party.

Furthermore, if the preset receiving party is a phone number, the sending control module 450 sends a text message via SMS containing the alarm to the phone number, and if the preset receiving party is an email address, the sending control module 450 sends an email containing the alarm to the email address.

Further, the electronic device includes a timer 70. The timer 70 begins timing after any signal generated by the sensing unit 20 and the timing is continued for as long as another sensed signal is not generated. The motion evaluating module 420 controls the timer 70 to start measuring time and determines whether the sensing unit 20 generates any further signal within the preset time period.

Furthermore, the electronic device 1 defines a deep sleeping mode, when the electronic device 1 enters the deep sleeping mode in which the electronic device 1 can consume a minimal amount of power while still communicating with other devices. The control unit 40 further includes a mode control module 460 to control the electronic device 1 to enter the deep sleeping mode as the sending control module 450 sends an alarm to the preset receiving party.

Therefore, the preset time period may be defined in the electronic device 1 according to the habits of a user. When the electronic device 1 is not moved during the preset time period, the electronic device 1 acquires a current location thereof and sends the location to the receiving party, which may be a phone number, or an e-mail address. Therefore, the user can track and know the location of the electronic device 1 in real time by a text message (SMS message) or by email.

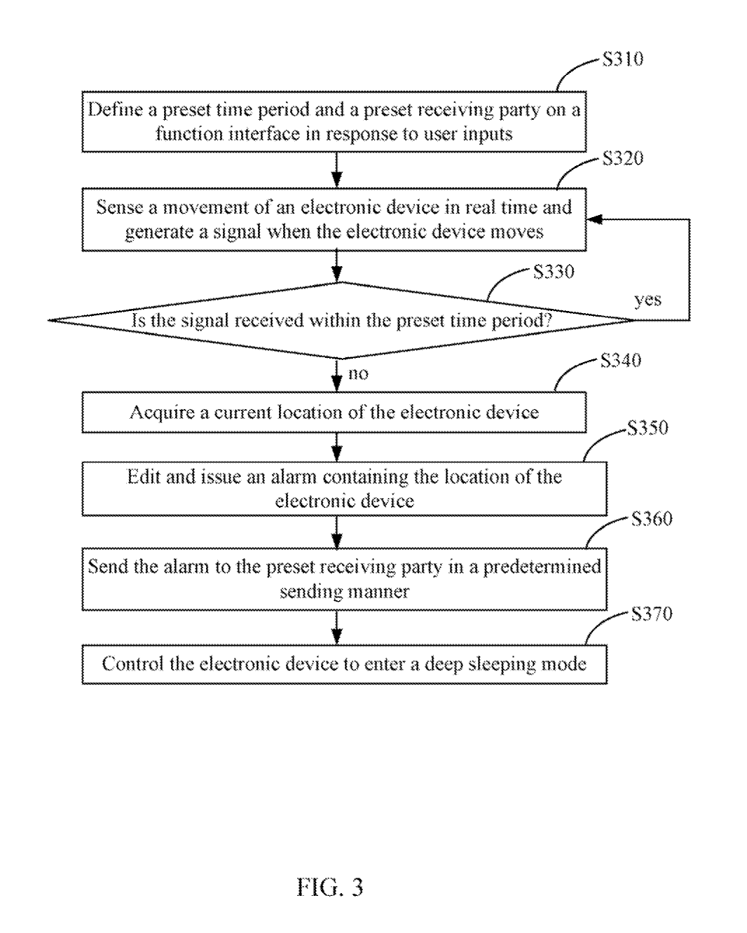

FIG. 3 is a flowchart of a method for tracking the electronic device of FIG. 1, according to one exemplary embodiment.

In step S310, the defining module 410 defines the preset time period and the preset receiving party on the function interface in response to user inputs.

In step S320, the sensing unit 20 senses a movement of the electronic device 1 in real time and generates a signal when the electronic device 1 moves.

In step S330, the motion evaluating module 420 determines whether the sensing unit 20 has generated a signal within the preset time period. If the sensing unit 20 does generate a signal within the preset time period, the procedure returns to step S320.

In step S340, if the sensing unit 20 does not generate any signal within the preset time period, the location acquiring module 430 acquires a current location of the electronic device 1 from the positioning unit 30.

In step S350, the editing module 440 edits and issues an alarm containing the current location of the electronic device 1 from the location acquiring module 430.

In step S360, the sending control module 450 controls the communication unit 60 to send the alarm to the preset receiving party in a predetermined sending manner.

In step S370, the mode control module 460 controls the electronic device 1 to enter the deep sleeping mode whenever the sending control module 450 sends an alarm to the preset receiving party.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a positioning unit to update a location of the electronic device in real time;
a communication unit to communicate with a preset receiving party;
a sensing unit to sense a movement of the electronic device in real time and generate a signal when the electronic device moves; and
a control unit comprising:
a motion evaluating module to determine whether the sensing unit has generated a signal within a preset time period;
a location acquiring module to acquire a current location of the electronic device from the positioning unit if the sensing unit did not generate a signal within the preset time period;
an editing module to edit and issue an alarm containing the current location of the electronic device from the location acquiring module; and
a sending control module to control the communication unit to send the alarm to the preset receiving party in a predetermined sending manner.

2. The electronic device as recited in claim 1, wherein the sensing unit is a G-sensor.

3. The electronic device as recited in claim 1, wherein the positioning unit is a GPS (Global Positioning System) receiver.

4. The electronic device as recited in claim 1, wherein the control unit comprises a defining module, the electronic device comprises a function interface, and the defining module is to define the preset time period and the preset receiving party on the function interface in response to user inputs.

5. The electronic device as recited in claim 1, further comprising a timer, wherein when the sensing unit does not generate a signal, the motion evaluating module controls the timer to start measuring time and determines whether the sensing unit does generate the signal within the preset time period.

6. The electronic device as recited in claim 1, wherein the electronic device defines a deep sleeping mode, when the electronic device enters the deep sleeping mode in which the electronic device can consume a minimal amount of power, the control unit further comprises a mode control module to control the electronic device to enter the deep sleeping mode whenever the sending control module sends the alarm to the preset receiving party.

7. The electronic device as recited in claim 1, wherein if the preset receiving party is a phone number, the sending control module sends a text message via SMS containing the alarm to the phone number, and if the preset receiving party is an email address, the sending control module sends an email containing the alarm to the email address.

8. A method for tracking an electronic device, wherein the electronic device comprises a positioning unit to update a location of the electronic device in real time and a sensing unit to sense a movement of the electronic device in real time and generate a signal when the electronic device moves, the method comprising:
determining whether the sensing unit has generated a signal within a preset time period;
if the sensing unit did not generate a signal within the preset time period, acquiring a current location of the electronic device from the positioning unit;
editing and issuing an alarm containing the current location of the electronic device; and
sending the alarm to a preset receiving party in a predetermined sending manner.

9. The method as recited in claim 8, wherein the sensing unit is a G-sensor.

10. The method as recited in claim 8, wherein the positioning unit is a GPS (Global Positioning System) receiver.

11. The method as recited in claim 8, wherein the electronic device comprises a function interface, further comprising:
defining the preset time period and the preset receiving party on the function interface in response to user inputs.

12. The method as recited in claim 8, the step “determining whether the sensing unit has generated a signal within a preset time period” further comprising:
if the sensing unit does not generate a signal, starting measuring time and determining whether the sensing unit has generated a signal within the preset time period.

13. The method as recited in claim 8, wherein the electronic device defines a deep sleeping mode, when the electronic device enters the deep sleeping mode in which the electronic device can consume a minimal amount of power, the method further comprising:
controlling the electronic device to enter the deep sleeping mode whenever sending the alarm to the preset receiving party.

14. The method as recited in claim 8, the step “sending the alarm to a preset receiving party in a predetermined sending manner” further comprising:
if the preset receiving party is a phone number, sending a message via SMS containing the alarm to the phone number; and
if the preset receiving party is an email address, sending an email containing the alarm to the email address.
